(19) United States
(12) Patent Application Publication
(10) Pub. No.: US 2014/0145105 A1
(43) Pub. Date: May 29, 2014

(54) DYE-SENSITIZED SOLAR CELL FOR VEHICLE

(71) Applicant: HYUNDAI MOTOR COMPANY, Seoul (KR)

(72) Inventors: Yong Jun Jang, Seongnam (KR); Sol Kim, Seoul (KR); Sang Hak Kim, Gunpo (KR); Ki Chun Lee, Seoul (KR); In Woo Song, Yongin (KR)

(73) Assignee: HYUNDAI MOTOR COMPANY, Seoul (KR)

(21) Appl. No.: 13/846,331

(22) Filed: Mar. 18, 2013

(30) Foreign Application Priority Data
Nov. 28, 2012 (KR) 10-2012-0136456

(51) Int. Cl. H01G 9/20

(52) U.S. Cl. CPC H01G 9/2013
USPC 252/62.2

(57) ABSTRACT

Disclosed is a dye-sensitized solar cell that includes an ionic liquid electrolyte, having an additive therein to increase durability and decrease the volatile nature of the conventional electrolytes.

### CROSS-REFERENCE TO RELATED PATENT APPLICATION

This application claims the benefit of Korean Patent Application No. 10-2012-0136456, filed on Nov. 28, 2012 in the Korean Intellectual Property Office, the disclosure of which is incorporated herein in its entirety by reference.

### BACKGROUND OF THE INVENTION

1. Field of the Invention

The present invention relates to a dye-sensitized solar cell.

2. Description of the Related Art

As problems relating to global warming have begun to emerge, the development of technologies for utilizing eco-friend energy has been spotlighted in the vehicle industry. One of the most popular fields among alternative energy sources is solar cells that utilize the sun's renewable energy. Examples of solar cells include silicon-based solar cells, thin-film solar cells that use an inorganic material, such as copper indium gallium selenide Cu(InGa)Se₂ (CIGS), dye-sensitized solar cells, organic solar cells, and organic-inorganic hybrid solar cells. Among them, dye-sensitized solar cells have become very popular in the portable electronic industry and build-integrated photovoltaics (BIPV) generation system industry because they are cheap and have compatible efficiency.

Dye-sensitized solar cells typically have solar cell systems that produce electricity via a photoelectric conversion mechanism by absorbing visible rays of light, unlike other solar cells which light is not absorbed but rather used to excite electrons in a semiconductor. However, dye-sensitized solar cells generally use low-boiling point liquid electrolyte as a building block. Water leakage may occur in the low-boiling point liquid electrolyte due to damage to a substrate of a solar cell. Due to this water leakage, salability is lowered, and consumers' health may be affected due to harmful risks of the low-boiling point solvent within the electrolyte.

For this reason, the concern about an electrolyte has recently increased. Typically, a low-boiling point electrolyte is used as a sealant for a solar cell. The low-boiling point electrolyte is very convenient to be injected into a module or to dissolve an additive. However, the low-boiling point electrolyte has a fatal drawback in that it does not satisfy long-term durability of the module. Also, due to the use of a volatile solvent during work, the low-boiling point electrolyte is easily evaporated, which may threaten workers' health. In particular, solar cells for vehicles have difficult evaluation conditions compared to solar cells that are installed in structures such as buildings and thus, the development of a new electrolyte is urgently required so that it may be used in the vehicle industry.

Some skilled in the art have suggested the use of a quasi-solid electrolyte including dialkylimidazolium styrenesulfonate, polydialkylimidazolium styrenesulfonate, or a combination thereof and a dye-sensitized solar cell using the same, or alternatively an electrolyte that includes a thermal treatment reaction product of imidazole, C₁-C₂₀ di-iodoalkane, and iodine and a solar cell employing the same. Furthermore, an imidazole-based polymer type or oligomer type ion solution, and a dye-sensitized solar cell using an electrolyte that does not include alkaline metal for supplying an electrolyte material to increase catalyst durability when a carbon nano-tube film that is cheaper than platinum is used as an opposite electrode have also been suggest. Finally, a new imidazolium compound and a pyridinium compound have been suggested as electrolyte products of a photocell in an electrochemical device using a liquid electrolyte as well. However, the compatibility of the above suggestions for use as an electrolyte of a dye-sensitized solar cell in a vehicle that has long-term durability is not sufficient in relation to the vehicle industrial standards.

### SUMMARY OF THE INVENTION

The purpose of the present invention is to improve long-term durability and efficiency of a module of a dye-sensitized solar cell by using a nonvolatile liquid electrolyte. In general, the liquid electrolyte in the solar cell flows outside of the module due to an existing polymer film and a glass frit type sealant. Thus, current density and efficiency of the solar cell are frequently reduced. As a result, these problems cause a reduction in the life span of a device and a large obstacle in relation to commercialization.

Accordingly, the exemplary embodiment of the present invention provides a dye-sensitized solar cell for a vehicle that uses nonvolatile ionic liquid, instead of a low-boiling point solvent which is typically used in an electrolyte so that the stability of a module may be maintained for an increased period of time and the durability of a solar cell may be improved so that it may be utilized safely in a vehicle. Also, efficiency of the solar cell provided by the present invention has also been increased.

The present invention relates to production of an electrolyte used to improve long-term durability of a solar cell and production of a dye-sensitized solar cell for a vehicle using the nonvolatile ionic liquid electrolyte. More specifically, the present invention relates to an electrolyte for a solar cell that utilizes a nonvolatile ionic liquid electrolyte and a dye-sensitized solar cell that is produced using the electrolyte for the solar cell. An existing low-boiling point electrolyte is quite volatile and thus it is harmful to a worker that may be manufacturing the solar cell, and an existing solar cell module may be easily destroyed due to the properties of the conventional electrolytes. Ionic liquid, however, is not harmful to the human body during manufacture due to its nonvolatile properties and is stable in the solar cell module for long term use. Also, efficiency may be stably maintained even in severe conditions. In addition, according to the present invention, higher efficiency than that of the low-boiling point electrolyte can be achieved and compatibility may be maximized.

Accordingly, the exemplary electrolyte containing the nonvolatile ionic liquid according to the present invention, is more particularly, an electrolyte which maintains stability during a durability test of the solar cell module and in which the solar cell module does not become destroyed during the durability test, unlike the existing low-boiling point electrolyte. Also, the electrolyte of the exemplary embodiment of the present invention has a higher efficiency than that of the existing compatible nonvolatile ionic liquid electrolyte. Furthermore, the exemplary embodiments of the present invention improve efficiency and remarkably improve durability compared to the existing low-boiling point electrolytes. More specifically, the existing electrolyte is very volatile when it is left alone at room temperature, and a module is frequently destroyed due to a low-boiling point of 85° C. (i.e., a durability evaluation condition). Also, due to a chemical toxicity of a solvent, such as acetonitrile or methoxy propionitrile that is used in the electrolyte, a sealant of the module is easily detached. On the other hand, in the electrolyte according to the exemplary embodiments of the present invention, the boiling point of the electrolyte is increased to 300° C. or higher by using ionic liquid and thus, the sealant is not destroyed during a long-term durability test of the module. Also, due to the optimized composition of an additive, high efficiency corresponding to the existing low-boiling point electrolyte has been achieved.

The ionic liquid of the nonvolatile electrolyte used in the present invention may be one or more selected from the group consisting of 1-propyl-3-methylimidazolium iodide, 1-butyl-3-methylimidazolium iodide, 1-hexyl-3-dimethylimidazolium iodide, 1-hexyl-2,3-dimethyl imidazolium iodide, 1-butylpyridinium iodide, 1-hexylpyridinium iodide, 1-ethyl-3-methyl imidazolium bis(trifluoromethanesulfonyl)imide, 1-ethyl-3-methylimidazolium dicyanamide, 1-ethyl-3-methylimidazolium tetrafluoroborate, 1-ethyl-3-methylimidazolium thiocyanate, and 1-ethyl-3-methylimidazolium selenocyanate. The ionic liquid may be used in an amount of 10 to 99 parts by weight, based on 100 parts by weight of an electrolyte solution. Notably, if the content of the ionic liquid is less than 10 parts by weight, solubility of an electrolyte additive is lowered beyond a desired level, and if the content of the ionic liquid exceeds 99 parts by weight, efficiency is rapidly lowered beyond a desired level and is thus not preferable. More preferably, the content of the ionic liquid may be 95 parts by weight, based on 100 parts by weight of the electrolyte solution.

The additive of the ionic liquid electrolyte may be LiI, NaI, KI, LiBr, NaBr, KBr, GuSCN, pyridine, tert-butyl pyridine, and a combination thereof. The additive may be in a single or mixed form. The electrolyte additive according to the exemplary embodiment of the present invention may be used in an amount of 1.0 to 10 parts by weight, based on 100 parts by weight of the electrolyte. If the content of the additive is less than 1.0 parts by weight, the efficiency of the solar cell is not stable, and if the content of the additive exceeds 10 parts by weight, the additive is not well dissolved in a solvent and thus a solid by-product is formed, which negatively influences a final electrolyte.

### BRIEF DESCRIPTION OF THE DRAWINGS

The above and other features and advantages of the present invention will become more apparent by describing in detail exemplary embodiments thereof with reference to the attached drawing in which:

FIG. 1 is a cross-sectional view of a dye-sensitized solar cell including an ionic liquid electrolyte according to an exemplary embodiment of the present invention.

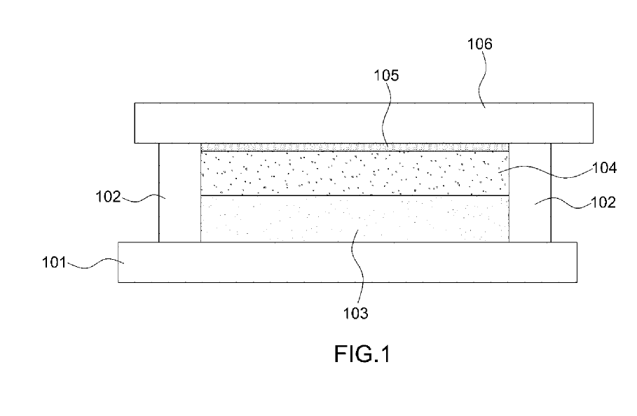

### DETAILED DESCRIPTION OF THE INVENTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

A process of producing a dye-sensitized solar cell according to an exemplary embodiment of the present invention will now be described below.

### First Embodiment

### Production of Electrolyte Including Ionic Liquid

In order to produce one exemplary electrolyte of the present invention, ionic liquid 1-propyl-3-methylimidazolium iodide 90 parts by weight and 2,6-di-tert-butylpyridine 4 parts by weight were stirred for one hour. NaI 3 parts by weight and potassium thiocyanate 3 parts by weight were put in a produced solution and were stirred for one hour.

### Second Embodiment

### Production of Electrolyte Including Ionic Liquid

In order to produce a second exemplary electrolyte of the present invention, ionic liquid 1-propyl-3-methylimidazolium iodide 90 parts by weight and tert-butyl pyridine 4 parts by weight were stirred for one hour. LiI 2 parts by weight, guanidine thiocyanate 2 parts by weight, and acetonitrile 2 parts by weight were put in a produced solution and were stirred for one hour.

### Third Embodiment

### Production of Electrolyte Including Ionic Liquid

In order to produce a third exemplary electrolyte of the present invention, ionic liquid 1-propyl-3-methylimidazolium iodide 90 parts by weight and tert-butyl pyridine 4 parts by weight were stirred for one hour. LiI 3 parts by weight and guanidine thiocyanate 3 parts by weight were put in a produced solution and were stirred for one hour.

### Production Example

### Production of Solar Cell by Using Electrolyte Including Ionic Liquid

A titanium dioxide paste for screen printing was coated on a glass substrate coated with fluorine doped tin oxide (FTO) by using screen printing equipment. The titanium dioxide paste was heated at 300° C. for one hour and fired at 500° C. for three hours. A dye (e.g., N3 manufactured by the Solaronix company,) was adsorbed onto a produced electrode at room temperature for 24 hours. Next, an ultraviolet hardener was applied to an outside of a photoelectrode having a TiO₂ coating layer into which the dye was adsorbed, a platinum opposite electrode substrate was put thereon and hardened by using ultraviolet hardening equipment. Each ionic liquid electrolyte produced according to the first through third embodiments was injected and sealed by the same ultraviolet hardening.

### Comparative Example

### Production of Solar Cell by Using Electrolyte Including Low-Boiling Point Solvent

The titanium dioxide paste for screen printing was coated again on a glass substrate coated with fluorine doped tin oxide (FTO) by using screen printing equipment. The titanium dioxide paste was again heated at 300° C. for one hour and fired at 500° C. for three hours. The dye (again manufactured by the Solaronix company, N3) was adsorbed onto a produced electrode at room temperature for 24 hours. The ultraviolet hardener was then applied to an outside of a photoelectrode having a TiO₂ coating layer into which the dye was adsorbed, a platinum opposite electrode substrate was put thereon and hardened by using ultraviolet hardening equipment. An electrolyte including a low boiling point solvent was injected and sealed by the same ultraviolet hardening.

Efficiency of each dye-sensitized solar cell produced according to the first through third embodiments and the comparative example is summarized in the following Table 1. In the case of a solar cell using ionic liquid according to the first through third embodiments, efficiency was stably maintained after acceleration durability evaluation (−40 to 85° C., 85RH%, 10 cycles, 60 hrs) is performed. On the other hand, in case of a solar cell using a low-boiling point electrolyte according to the comparative example, a sealant of the solar cell was destroyed due to the non-volatile electrolyte and produced a much lower efficiency.

TABLE 1

| | Energy conversion | Energy conversion | Variation of |
|---|---|---|---|
| | efficiency before | efficiency after | efficiency |
| | acceleration | acceleration | before |
| | durability | durability | and after |
| Samples | evaluation (%) | evaluation (%) | evaluation (%) |
| First | 3.5 | 3.4 | 97.14 |
| embodiment | | | |
| Second | 4.5 | 4.3 | 95.55 |
| embodiment | | | |
| Third | 3.4 | 3.2 | 94.12 |
| embodiment | | | |
| Comparative | 3.6 | 0.5 | 13.89 |
| example | | | |

As described above, advantages of an electrolyte including ionic liquid according to the exemplary embodiments of the present invention are as follows. A durability evaluation specification of a vehicle has a very difficult evaluation criterion compared to a solar cell for a structure. As a result of using an ionic liquid electrolyte, uniform solar cell efficiency is shown in an acceleration durability condition. In a dye-sensitized solar cell according to the present invention, durability is significantly increased in comparison to the conventional low-boiling point electrolyte.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An ionic liquid electrolyte composition comprising an ionic liquid electrolyte, including an additive configured to increase the durability and decrease a volatile properties of the electrolyte.

2. The ionic liquid electrolyte composition of claim 1, wherein ionic liquid of the ionic liquid electrolyte is used in an amount of 10 to 99 parts by weight, based on 100 parts by weight of the ionic liquid electrolyte composition.

3. The ionic liquid electrolyte composition of claim 2, wherein ionic liquid of the ionic liquid electrolyte is used in an amount of 70 to 99 parts by weight, based on 100 parts by weight of the ionic liquid electrolyte composition.

4. The ionic liquid electrolyte composition of claim 1, wherein the ionic liquid is one or more selected from the group consisting of 1-hexyl-2,3-dimethyl imidazolium iodide, 1-butylpyridinium iodide, 1-hexylpyridinium iodide, 1-ethyl-3-methyl imidazolium bis(trifluoromethanesulfonyl)imide, 1 -ethyl-3 -methylimidazolium dicyanamide, 1-ethyl-3-methylimidazolium tetrafluoroborate, 1-ethyl-3-methylimidazolium thiocyanate, 1-ethyl-3-methylimidazolium selenocyanate, 1-propyl-3-methylimidazolium iodide, 1-butyl-3-methylimidazolium iodide, and 1-hexyl-3-dimethylimidazolium iodide.

5. The ionic liquid electrolyte composition of claim 4, wherein the ionic liquid is 1-propyl-3-methylimidazolium iodide.

6. The ionic liquid electrolyte composition of claim 1, wherein the additive is a pyridine-based additive, is one or more selected from the group consisting of pyridine, 4-(aminomethyl)pyridine, 2-(methylamino)pyridine, 3-hydroxy-6-(tert-butyl)pyridine, 2,6-di-tert-butylpyridine, 4-tert-butylpyridine, and a combination thereof, and is used in an amount of 1.0 to 10 parts by weight, based on 100 parts by weight of the ionic liquid electrode composition.

7. The ionic liquid electrolyte composition of claim 1, wherein the additive is a metal iodine-based additive, is one or more selected from the group consisting of sodium iodide, potassium iodide, tetrabutylammonium iodide, lithium iodide, ammonium iodide, allyl iodide, calcium iodide, magnesium iodide, and a combination thereof, and is used in an amount of 1.0 to 10 parts by weight, based on 100 parts by weight of the ionic liquid electrode composition.

8. The ionic liquid electrolyte composition of claim 1, wherein the additive is a thiocyanate-based additive, is one or more selected from the group consisting of ammonium thiocyanate, 4-hydroxy-3-methylphenyl thiocyanate, hexyl thiocyanate, potassium thiocyanate, guanidine thiocyanate, sodium thiocyanate, methyl thiocyanate, ethyl thiocyanate, tetrabutylammonium thiocyanate, benzyl thiocyanate, and a combination thereof, and is used in an amount of 1.0 to 10 parts by weight, based on 100 parts by weight of the ionic liquid electrode composition.

9. The ionic liquid electrolyte composition of claim 1, wherein the additive is a low-boiling point solvent-based additive, is one or more selected from the group consisting of ethylene carbonate, dimethyl carbonate, ethylmethyl carbonate, diethyl carbonate, propionitrile, benzyl cyanide, succinonitrile, valeronitrile, acetonitrile, 3-methoxy propionitrile, and a combination thereof, and is used in an amount of 1.0 to 10 parts by weight, based on 100 parts by weight of the ionic liquid electrode composition.

10. A dye-sensitized solar cell comprising an ionic liquid electrolyte, including an additive configured to increase the durability and decrease volatile properties of the electrolyte .

11. The dye-sensitized solar cell of claim 10, wherein the solar cell is configured to provide energy in a vehicle.

12. The dye-sensitized solar cell of claim 11, wherein ionic liquid of the ionic liquid electrolyte is used in an amount of 10 to 99 parts by weight, based on 100 parts by weight of the ionic liquid electrolyte composition.

13. The dye-sensitized solar cell of claim 12, wherein ionic liquid of the ionic liquid electrolyte is used in an amount of 70 to 99 parts by weight, based on 100 parts by weight of the ionic liquid electrolyte composition.

14. The dye-sensitized solar cell of claim 11, wherein the ionic liquid is one or more selected from the group consisting of 1-hexyl-2,3-dimethyl imidazolium iodide, 1-butylpyridinium iodide, 1-hexylpyridinium iodide, 1-ethyl-3-methyl imidazolium bis(trifluoromethanesulfonyl)imide, 1 -ethyl-3 -methylimidazolium dicyanamide, 1-ethyl-3-methylimidazolium tetrafluoroborate, 1-ethyl-3-methylimidazolium thiocyanate, 1-ethyl-3-methylimidazolium selenocyanate, 1-propyl-3-methylimidazolium iodide, 1-butyl-3-methylimidazolium iodide, and 1-hexyl-3-dimethylimidazolium iodide.

15. The dye-sensitized solar cell of claim 14, wherein the ionic liquid is 1-propyl-3-methylimidazolium iodide.

16. The dye-sensitized solar cell of claim 11, wherein the additive is a pyridine-based additive, is one or more selected from the group consisting of pyridine, 4-(aminomethyl)pyridine, 2-(methylamino)pyridine, 3-hydroxy-6-(tert-butyl)pyridine, 2,6-di-tert-butylpyridine, 4-tert-butylpyridine, and a combination thereof, and is used in an amount of 1.0 to 10 parts by weight, based on 100 parts by weight of the ionic liquid electrode composition.

17. The dye-sensitized solar cell of claim 11, wherein the additive is a metal iodine-based additive, is one or more selected from the group consisting of sodium iodide, potassium iodide, tetrabutylammonium iodide, lithium iodide, ammonium iodide, allyl iodide, calcium iodide, magnesium iodide, and a combination thereof, and is used in an amount of 1.0 to 10 parts by weight, based on 100 parts by weight of the ionic liquid electrode composition.

18. The dye-sensitized solar cell of claim 11, wherein the additive is a thiocyanate-based additive, is one or more selected from the group consisting of ammonium thiocyanate, 4-hydroxy-3-methylphenyl thiocyanate, hexyl thiocyanate, potassium thiocyanate, guanidine thiocyanate, sodium thiocyanate, methyl thiocyanate, ethyl thiocyanate, tetrabutylammonium thiocyanate, benzyl thiocyanate, and a combination thereof, and is used in an amount of 1.0 to 10 parts by weight, based on 100 parts by weight of the ionic liquid electrode composition.

19. The dye-sensitized solar cell of claim 11, wherein the additive is a low-boiling point solvent-based additive, is one or more selected from the group consisting of ethylene carbonate, dimethyl carbonate, ethylmethyl carbonate, diethyl carbonate, propionitrile, benzyl cyanide, succinonitrile, valeronitrile, acetonitrile, 3-methoxy propionitrile, and a combination thereof, and is used in an amount of 1.0 to 10 parts by weight, based on 100 parts by weight of the ionic liquid electrode composition.
